(19) United States
(12) Patent Application Publication
(10) Pub. No.: US 2026/0118730 A1
(43) Pub. Date: Apr. 30, 2026

(54) CONTEXT-AWARE CUBICLE SYSTEM WITH ELECTROCHROMIC GLASS PANELS AND FEEDBACK-CONTROLLED DESK ADJUSTMENT

(71) Applicant: Versa Products Inc., Los Angeles, CA (US)

(72) Inventor: Christopher Laudadio, Los Angeles, CA (US)

(21) Appl. No.: 19/375,138

(22) Filed: Oct. 30, 2025

Related U.S. Application Data
(60) Provisional application No. 63/714,360, filed on Oct. 31, 2024.

(51) Int. Cl. G02F 1/163; E04B 2/74; E06B 9/24; G02F 1/153

(52) U.S. Cl. CPC G02F 1/163; E04B 2/74; E06B 9/24; G02F 1/153; E04B 2002/7483; E06B 2009/2464

(57) ABSTRACT

A cubicle system includes multiple electrochromic glass panels and a height-adjustable desk controlled by a context-aware control system. Each glass panel transitions between transparent and opaque states in response to voltages generated by the controller. The controller receives signals from sensors including posture, noise, light, and presence sensors, computes a privacy-requirement value based on the sensor inputs, and adjusts the transmittance of each panel to achieve a corresponding privacy level. Optical feedback from the panels is used to refine voltage control and maintain the desired transmittance within a defined tolerance. The controller may also coordinate desk height adjustments with user posture and synchronize transparency settings among adjacent cubicles through a network connection. The system thereby provides an adaptive workspace that dynamically regulates privacy and lighting conditions according to environmental and user context.

### CROSS-REFERENCE TO RELATED APPLICATIONS

This application claims the benefit of U.S. Patent Appl. No. 63/714,360, titled “GLASS CUBICLES WITH ELECTRONICALLY DIMMABLE LIGHTS AND HEIGHT ADJUSTABLE DESK,” filed on Oct. 31, 2024, the entire disclosure of which is hereby incorporated by reference in its entirety.

### BACKGROUND OF THE INVENTION

### Field of the Art

The disclosure relates to the field of workstations, and more particularly to the field of open cubicles with electronically dimmable glass panels.

### Discussion of the State of the Art

Traditional office environments have relied on fixed cubicle partitions or static glass walls to separate individual work areas. While such configurations provide some visual distinction between workspaces, they do not actively respond to changing user needs or environmental conditions. In recent years, open-plan office designs have become prevalent in an effort to promote collaboration and reduce spatial constraints. Although these layouts encourage interaction among employees, numerous observations indicate that open offices often result in increased noise, visual distractions, and interruptions, leading to measurable reductions in employee productivity and concentration.

Existing open-office environments typically lack a technical mechanism for dynamically balancing collaboration and privacy. When employees require focus for concentrated tasks or confidential communications, they must manually relocate to private rooms or rely on ad hoc visual cues to signal unavailability. Similarly, lighting conditions and desk ergonomics must be adjusted manually, often resulting in inconsistent comfort levels and inefficient use of workspace resources. Conventional glass partitions, even when aesthetically appealing, remain passive structures that cannot adapt their optical properties or interact with user behavior.

These limitations arise because conventional office systems lack integrated sensing and electronic control capable of continuously regulating environmental variables such as light transmission, acoustic isolation, and ergonomic position.

Accordingly, there exists a need for a cubicle system that provides the openness and visibility associated with modern office layouts while automatically creating conditions conducive to focused work when required. A system that integrates environmental sensing, user detection, and electronic control of glass transparency and desk position can dynamically optimize both collaboration and concentration, leading to tangible improvements in user comfort, communication flow, and overall productivity in the workplace.

### SUMMARY OF THE INVENTION

The present invention provides a cubicle system that automatically regulates the optical transmittance of electrochromic glass panels according to real-time environmental and user context. The system comprises multiple electrochromic glass panels arranged around a workspace and configured to transition between transparent and opaque states in response to applied voltages. A controller containing at least one processor, memory, and a driver circuit is operatively coupled to the glass panels and to a plurality of sensors configured to detect conditions within and around the cubicle. The sensors may include, for example, a posture sensor for detecting whether a user is seated or standing, a noise sensor for monitoring ambient sound levels, a light sensor for measuring illumination, and a presence detector for identifying user occupancy.

The controller is programmed to acquire context signals from the sensors, evaluate the signals to determine a privacy-requirement value, and map that value to a corresponding set of target transmittance levels for the electrochromic glass panels. The controller then generates and applies control voltages through the driver circuit to achieve the desired transmittance levels. Each glass panel may be controlled independently so that upper, middle, and lower panels provide different degrees of transparency depending on user posture, environmental brightness, or noise level.

The controller further includes feedback logic that monitors the optical transmittance of each panel through integrated or external light sensors, compares the measured transmittance with the target value, and adjusts the applied voltage until the difference falls within a defined tolerance range. This closed-loop operation maintains stable optical performance and compensates for variations in material response, temperature, or external lighting conditions. The feedback logic may also enforce slew-rate limits that restrict the rate of change in transmittance to prevent abrupt visual transitions and to prolong the life of the electrochromic material.

In certain embodiments, the controller provides a manual override interface that allows a user to temporarily set a desired transparency or lighting level. The override may be initiated through a local control surface or wireless application and stored in memory as a user preference for future operation. The cubicle may further include a height-adjustable desk driven by a motorized actuator controlled by the same controller, enabling coordinated adjustment of desk height and glass opacity in response to the detected posture of the user.

In multi-cubicle environments, each cubicle controller may communicate over a local or wireless network with controllers of adjacent cubicles. Through this communication, the system can synchronize the transmittance of panels across multiple workstations, establish transparency gradients around shared spaces, or create coordinated transitions for collaborative work sessions.

A corresponding method is provided for controlling the opacity of the electrochromic glass panels. The method includes acquiring and validating context signals from the sensors, determining whether sufficient data is available to compute the privacy-requirement value, applying a default transmittance profile when sufficient data is not available, computing the privacy-requirement value when sufficient data is available, mapping the value to target transmittance levels for the panels, outputting voltages to achieve the targets, measuring actual transmittance, and adjusting the voltages in a feedback loop until the measured transmittance is within a defined tolerance range.

In another embodiment, a non-transitory computer-readable medium stores instructions that, when executed by the controller, perform the method steps described above. Together, these embodiments provide a deterministic, sensor-driven control architecture that enhances user comfort and privacy in an open workspace while delivering a concrete technological improvement in the automatic regulation of electrochromic materials.

By combining real-time sensor input with closed-loop voltage regulation of electrochromic glass, the invention provides a measurable improvement in environmental control precision, energy efficiency, and user comfort compared with conventional manually operated systems.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary and are not to be considered as limiting of the scope of the invention or the claims herein in any way.

FIG. 1A is a perspective view of a cubicle with a height adjustable desk, in accordance with an embodiment of the invention.

FIG. 1B is a perspective view of the height adjustable desk of the cubicle, in accordance with an embodiment of the invention.

FIG. 1C is a left side view of the height adjustable desk of the cubicle, in accordance with an embodiment of the invention.

FIG. 1D is a right-side view of the height adjustable desk of the cubicle, in accordance with an embodiment of the invention.

FIG. 1E is a front view of the height adjustable desk of the cubicle, in accordance with an embodiment of the invention.

FIG. 1F is a back view of the height adjustable desk of the cubicle, in accordance with an embodiment of the invention.

FIG. 1G is a top view of the height adjustable desk of the cubicle, in accordance with an embodiment of the invention.

FIG. 2 is a perspective view of cubicle operating in a complete private configuration, in accordance with an embodiment of the invention.

FIG. 3 is a perspective view of cubicle in which glass panels in the top and middle layer are dimmed, in accordance with an embodiment of the invention.

FIG. 4 is a perspective view of cubicle in which glass panels in the middle and bottom layer are dimmed, in accordance with an embodiment of the invention.

FIG. 5 is a perspective view of cubicle in which glass panels in the top layer are dimmed, in accordance with an embodiment of the invention.

FIG. 6 is a perspective view of cubicle in which glass panels in the top and middle layer of cubicle are dimmed, in accordance with an embodiment of the invention.

FIG. 7 is a block diagram illustrating an exemplary hardware architecture of a computing device used in an embodiment of the invention.

FIG. 8 is a block diagram illustrating a context-adaptive control system for regulating electrochromic glass panels and desk position in response to user and environmental inputs.

FIG. 9 is a flow diagram illustrating an exemplary method for controlling electrochromic glass opacity based on contextual data and feedback signals.

### DETAILED DESCRIPTION

The inventor has conceived and reduced to practice an innovative cubicle system that integrates smart technology, adaptive environments, and user-centric design. Cubicles with glass panels having electronically dimmable technology enable users to switch between a private cubicle workspace and open cubicle workspace. A height adjustable desk is integrated in the glass cubicle for providing a sit-stand desk configuration. The opacity of individual glass panels and height of the desk can be electronically automated based on users' position and activity. Glass panels in each layer of cubicle can be individually controlled, and multiple configurations of cubicle can be generated for different types of work activities.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

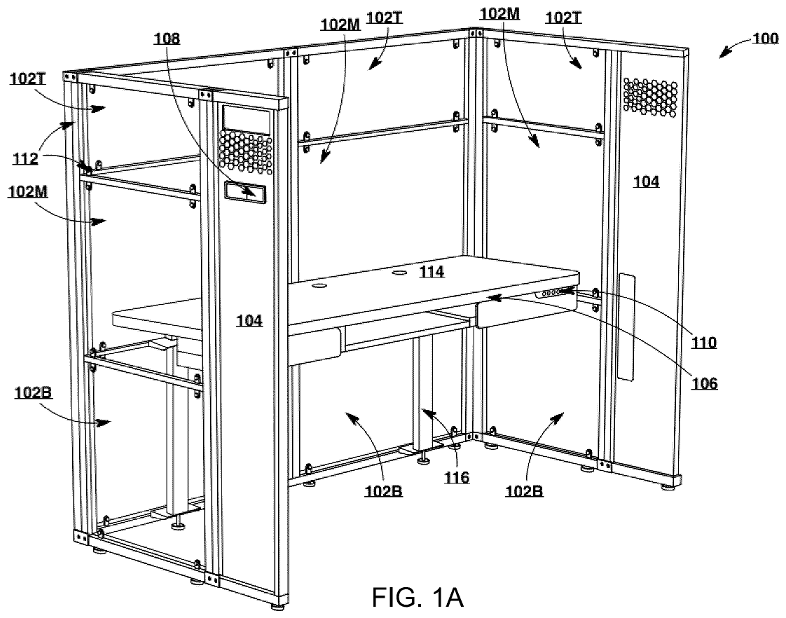

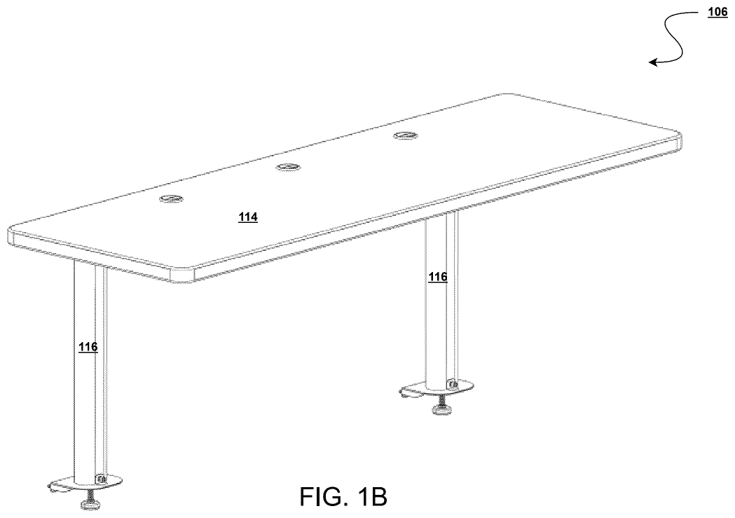

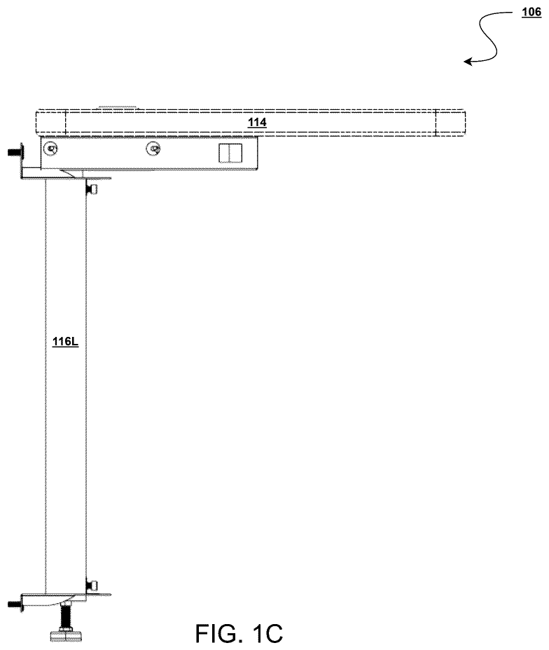

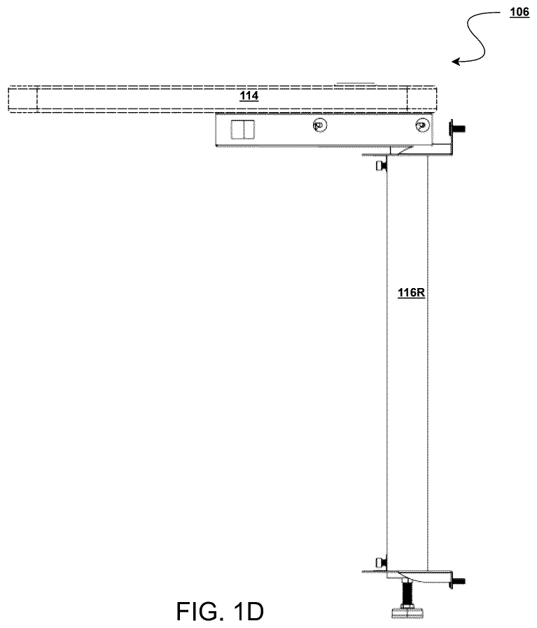

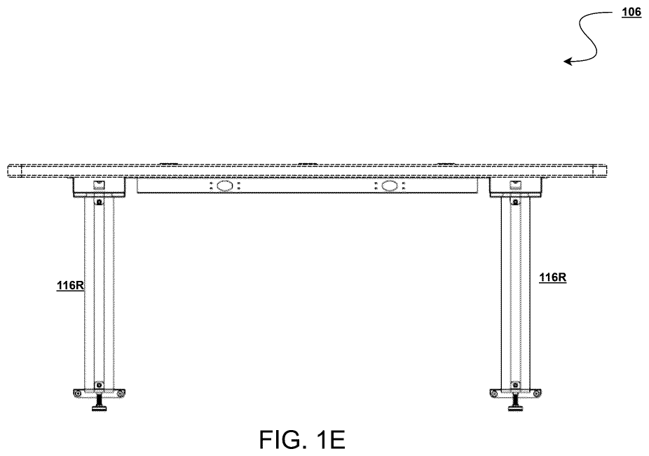

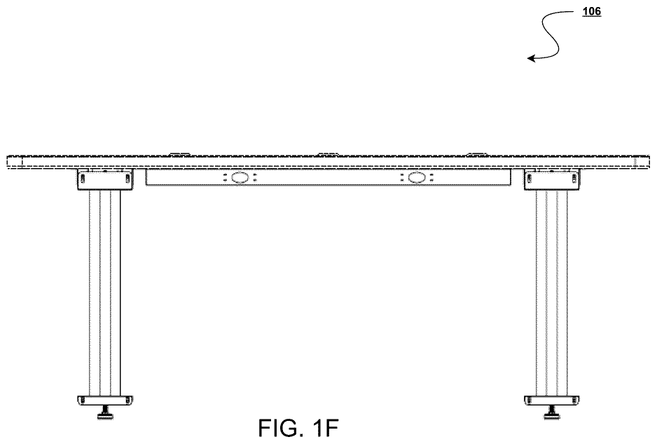

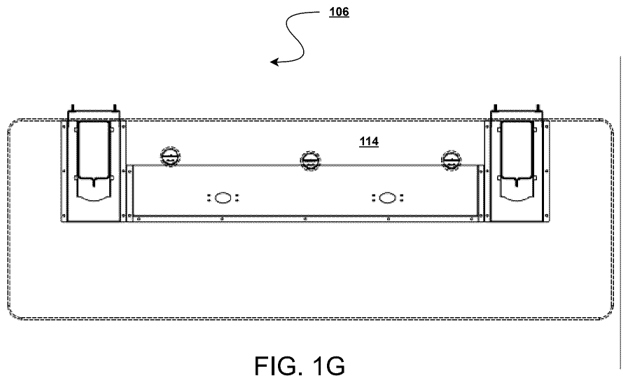

FIG. 1A is a perspective view of cubicle 100 with a height-adjustable desk 106, in accordance with an embodiment of the invention. Cubicle 100 may be constructed using multiple glass panels and includes an integrated height adjustable desk 106.

In an embodiment, glass panels 102T, 102M, and 102B (collectively referred to as “glass panels 102”) are present in the top layer, middle layer, and bottom layer of cubicle 100. Unlike existing open office plans in which glass panels are merely static partitions, glass panels 102 described herein incorporate electrochromic technology for dynamic opacity adjustment.

In an embodiment, glass panels 102 may be electrochromic glass that contains a thin layer of electrochromic material sandwiched between two layers of glass. Electrochromic glass panels 102 include two outer layers of transparent conductive oxide (TCO) coated glass, an active electrochromic layer, an electrolyte layer, and an ion storage layer. When a low voltage is applied across the TCO layers, ions (usually lithium or hydrogen) move from the ion storage layer through the electrolyte into the electrochromic layer. The insertion of ions causes the electrochromic layer to change its optical properties, typically darkening and reducing light transmission. Reversing the voltage causes the ions to move back to the ion storage layer, returning the glass to its transparent state. When an electric current is applied, the material changes its opacity.

An electric current may be applied to the glass to change the lumen levels. A lower lumen level may make the glass opaque, and a higher lumen level may make the glass transparent. Control is often provided through controller 110 in cubicle 100, a remote control, or a smartphone app, allowing users to adjust the glass opacity as needed. FIG. 1A shows an open cubicle configuration in which the glass panels 102 are transparent.

In an embodiment, controller 110 may be used for adjusting the lumen levels of the glass panels 102. Controller 110 based on instruction received from a user device may vary the amount of electric current applied to glass panels 102. Higher voltage typically results in clearer glass (more light transmission), while lower voltage results in more tinted glass (less light transmission). In an embodiment, a small graphical user interface (GUI) may be present as part of controller 110. The GUI may include but is not limited to a digital height display, memory settings, and mode selection for glass panels 102.

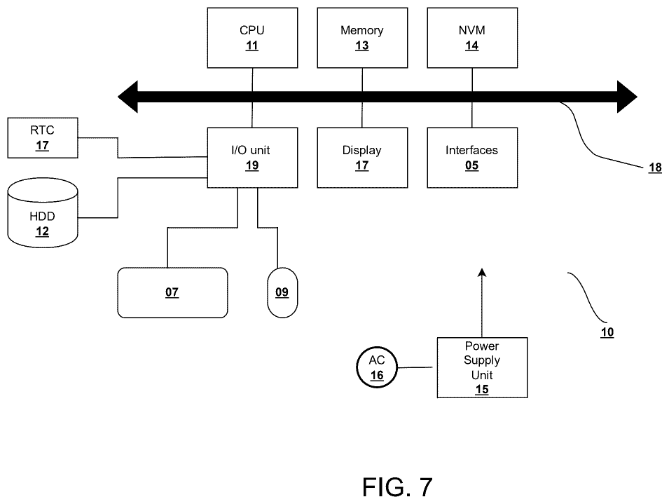

In an embodiment, controller 110 may comprise a specially programmed CPU (Central Processing Unit), memory, and input/output peripherals. The CPU, memory, and input/output peripherals are similar to the CPU, memory, and input/output peripherals described in FIG. 7.

In an embodiment, controller 110 may be part of cubicle system integrated with cubicle 100 to control its operation. In another embodiment, controller 110 may be part of user device that pairs with cubicle 100 and controls the voltage provided to glass panels 102. In an embodiment, cubicle 100 is fully controllable via a Bluetooth remote App.

Controller 110 may reside on the user device, and the user device may connect with a computer (Refer to FIG. 7) integrated with cubicle 100. In an embodiment, a user device may be connected to controller 110 via a short-range communication protocol. Short-range communication protocols may include Bluetooth, Wi-Fi, NearLink, near-field communication (NFC), LPWAN, ultra-wideband (UWB), and IEEE 802.15. 4. In some cases, the user device may include a lighting application that communicates with glass panels 100 of cubicle 100.

In an embodiment, height-adjustable desk 106 may be used in a sit-and-stand configuration. Desk 106 moves up and down to provide a stand-up position and moves down to provide a sit-down position for the user of cubicle 100 using controller 110. Desk surface 114 may include pre-drilled grommet holes or mounting points (visible along the edges and in various locations across desk surface 114) for connecting monitors.

Height-adjustable desk 106 may be made of thick solid bamboo or any other wood. In some cases, desk 106 may be made of other materials including but not limited to laminate, metal, and glass. Desk surface 114 may be used for mounting monitors. Several pre-drilled grommet holes or mounting points are visible along the edges and in various locations across the surface 114 for connecting monitors. In an embodiment, there may be nine pre-drilled grommet holes to easily mount one or two monitors. The incorporation of grommet holes allows users to maximize desk space by efficiently utilizing monitor arms and other accessories, thereby enhancing the desk's functionality and user convenience. Further, height-adjustable desk 106 may include additional surfaces for keeping laptops, books, and any other items. In some cases, an additional keyboard tray may be provided as part of height-adjustable desk 106.

In an embodiment, height-adjustable desk 106, can be automatically reconfigured to accommodate multiple users. In cases where two users are detected, desk 106 may adjust to a middle height that's comfortable for both standing and seated participants.

In an embodiment, a pressure-sensitive floor mat may be used to determine the user's standing position, weight distribution, and potential signs of fatigue. The pressure-sensitive floor mat may be connected to controller 110. The pressure-sensitive floor mat may use capacitive or resistive pressure sensing and may be capable of detecting pressure changes of 0.1 N/cm². Further, data from proximity sensors in the cubicle walls may be used to track the user's distance from the desk and walls. Proximity sensors may include infrared or ultrasonic sensors. Two to four proximity sensors may be fixed on each glass panel layer.

In an embodiment, the cubicle system described may use an adaptive control algorithm to understand and predict user preferences. The height adjustment of desk 106 may be performed automatically based on the user's position, activity, and learned patterns. For example, if the system detects through the data from the pressure-sensitive floor mat that the user is shifting weight frequently, it may be indicative of fatigue. The user may be sent a message suggesting lowering desk 106 to a sitting position. This message may be in the form of a health prompt. Further, health prompts may include posture changes and breaks to promote user health and prevent fatigue. Further, over a period, the adaptive control algorithm may learn user patterns including, but not limited to factors such as time of day, scheduled tasks, and even physiological data. This allows the system to preemptively adjust the desk settings to suit the user's needs. FIG. 1A depicts a C-shaped glass cubicle, other types of glass cubicles with an L shape, H shape, or T shape, or even one with a door and roof may be constructed.

FIG. 1B is a perspective view of the height-adjustable desk 106 of cubicle 100, in accordance with an embodiment of the invention. Vertical support members 116 may be connected to desk surface 114 using connectors. Rollers (pinion gears) may be attached to vertical support members 116 and rollers may engage with the track on a stationary vertical support member to provide vertical movement of desk surface 114. The vertical support member 116 may be attached to cubicle glass panels 102.

FIGS. 1C and 1D are left-side views and right-side views of the height-adjustable desk 106. Height adjustable desk 106 may be supported by vertical support members 116L and 116R. FIGS. 1E and 1F are the front view and back view of the height adjustable desk 106. FIG. 1G is the top view of the height-adjustable desk 114.

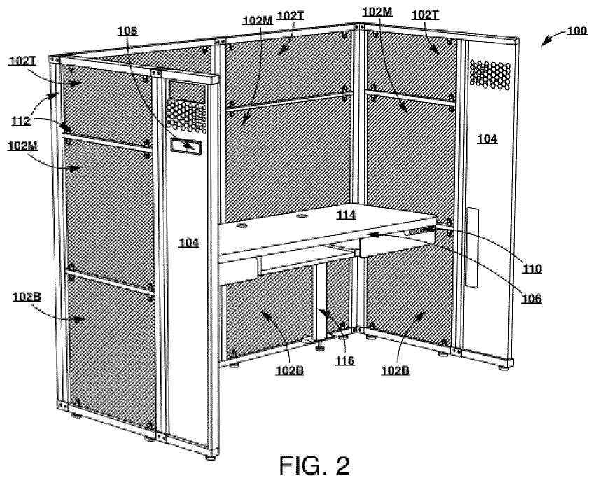

FIG. 2 is a perspective view of cubicle 100 operating in a complete private configuration, in accordance with an embodiment of the invention. Glass panels 102 in all the layers are dimmed. The open cubicle 100 becomes a private cubicle. In an embodiment, a GUI in controller 110 may include settings to switch between private mode and open mode. The electrochromic layer composition and electrolyte conductivity of glass panels 102 may be optimized to transition from fully transparent to fully opaque (from open configuration to private configuration) and from fully opaque to fully transparent (from private configuration to open configuration). The configuration shown in FIG. 2 is ideal for handling confidential information, private conversations, or when the user requires complete focus on the task without visual distractions.

In an embodiment, users can gradually adjust the transparency of the glass panels 102. This means users can fine-tune the opacity and light transmission to desired levels. Users can control the electric current being applied, and based on the electric current the material changes its opacity, allowing more or less light to pass through. The electric current may be applied to the glass to change the lumen levels. A lower lumen level may darken the glass, and a higher lumen level may make the glass transparent. The lumen levels for glass panels 102 may be controlled via the user device. Controller 110 may receive the user selection from the user device and adjust the lumen levels accordingly. A lower voltage results in more tinted glass (less light transmission) for providing a private mode.

In an embodiment, a networked office environment enables cubicles to be connected and controlled by the cubicle system. This networked office environment enables individual cubicles on the office floor to coordinate with nearby cubicles for collaborative work sessions. In an embodiment, multiple cubicles may synchronize their glass panels 102 transparency settings, to create a larger, visually connected space. This coordinated action helps in the generation of automatic meetings for a group of individual cubicles into an impromptu meeting area.

For example, when a group meeting or any other larger collaborative session is detected or initiated, the system may guide users to create ad-hoc meeting spaces by clustering nearby cubicles. This clustering may involve coordinated transparency changes, desk height adjustments, and even subtle lighting cues to delineate the temporary meeting area.

Further, the system may create privacy gradients around collaborative spaces. For example, cubicles directly adjacent to the meeting area might have partial transparency, while cubicles further away maintain full opacity, balancing openness with the need for focus in non-participating areas. The glass opacity automatically adjusts based on the user's position (standing or sitting) and current activity (e.g., individual work, collaboration, video calls).

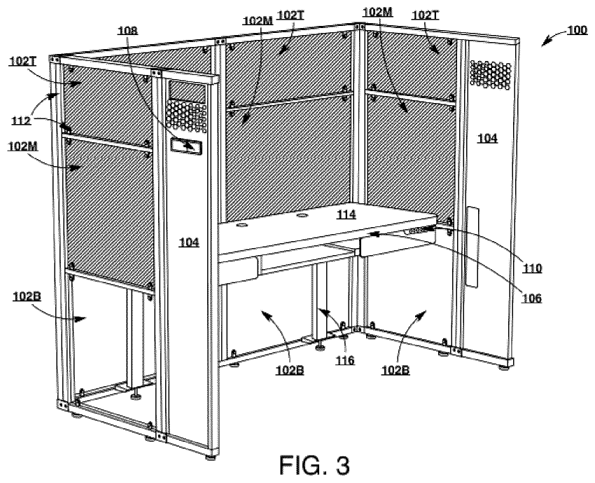

FIG. 3 is a perspective view of cubicle 100 in which glass panels 102 in the top layer 102T and middle layer 102M are dimmed. The bottom layer 102B remains transparent. In an example scenario, this configuration of dimming allows the employee sitting on a chair to a partial privacy by covering the monitor on desk surface 114. In some cases, the partial transparency signals to others that a meeting is in progress, discouraging interruptions. Further, the configuration shown in FIG. 3 may be ideal for small group collaborations involving sensitive information, allowing easy access while maintaining privacy for displayed content.

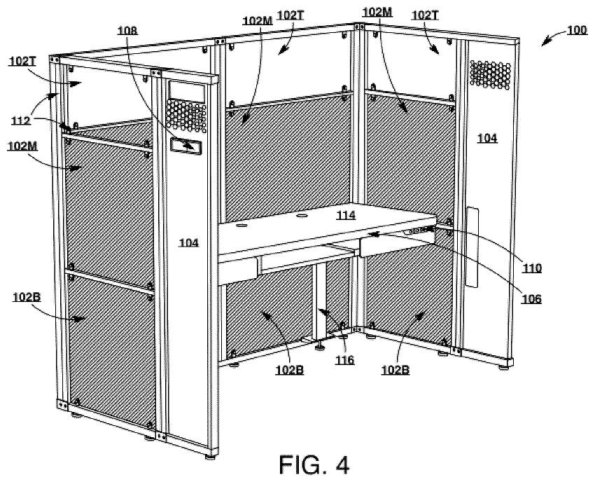

FIG. 4 is a perspective view of cubicle 100 in which glass panels 102 in the middle layer 102M and bottom layer 102B are dimmed. The top layer 102T remains transparent. This allows the employee sitting on a chair partial privacy while allowing natural light from above. Colleagues can easily see if the user is in cubicle 100 without disturbing the user's time. Further, the configuration shown in FIG. 4 may be ideal for personal activities during work hours, providing privacy while still maintaining a connection to the office environment.

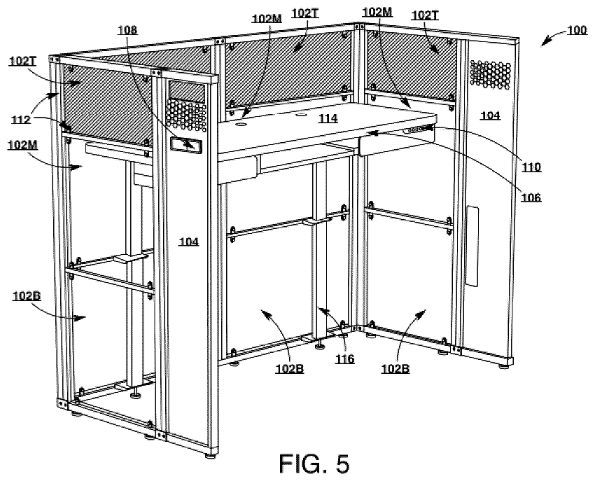

FIG. 5 is a perspective view of cubicle 100 in which glass panels 102 in the top layer 102T are dimmed and height adjustable desk 106 is in a standing position. The middle 102M and bottom 102B layers remain transparent. This allows the employee standing partial privacy by covering the employee's face and computer screen on desk surface 114. The configuration shown in FIG. 5 may be ideal for focused work on sensitive materials while using a standing desk. This configuration provides both privacy and openness.

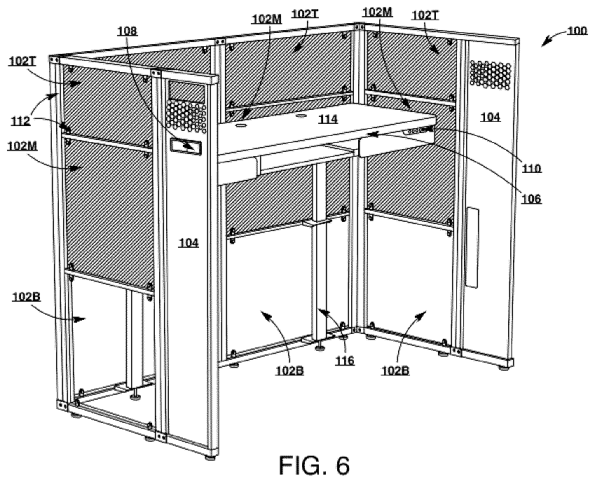

FIG. 6 is a perspective view of cubicle 100 in which glass panels 102 in the top layer 102T and middle layer 102M are dimmed and height adjustable desk 106 is in a standing position. The bottom layer 102B remains transparent. This allows the employee standing partial privacy by covering the employee's upper body and computer screen on desk surface 114. Colleagues can see easily see if the user is in cubicle 100 without disturbing the user's time. The configuration shown in FIG. 6 may be ideal for activities requiring privacy of displayed information and upper body movements, such as presentation practice or video conference calls while standing.

The different configurations depicted in FIGS. 1-7 allows users to create environments for a wide range of activities, from confidential tasks to collaborative tasks, while maintaining the benefits of an open office layout when needed.

Although FIGS. 2-7 depict similar levels of transparency, it should be understood that the level of transparency or dimness can be pre-configured for different scenarios, users, and times of the day. Further, it should be understood that other configurations of dimming of glass panels 102 may be possible.

Referring now to FIG. 7, there is shown a block diagram depicting an exemplary computing device 10 suitable for implementing at least a portion of the features or functionalities disclosed herein. Computing device 10 may be used in the cubicle system used by cubicle 100. Computing device 10 may be, for example, any one of the computing machines listed in the previous paragraph, or indeed any other electronic device capable of executing software- or hardware-based instructions according to one or more programs stored in memory. Computing device 10 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

CPU 11 is connected to bus 18, memory 13, non-volatile memory (NVM) 14, display 17, I/O unit 19, and Interfaces 5. I/O unit 19 may, typically, be connected to keyboard 09, pointing device 09, hard disk 12, and real-time clock (RTC) 17. Interfaces 05 are designed to connect to a network, which may be the Internet or a local network, which local network may or may not have connections to the Internet. Also shown as part of computing device 10 is power supply unit 15 connected, in this example, to ac supply 16.

I/O unit 19 may include input and out devices. Input devices may be of any type suitable for receiving user input, including for example a keyboard, touchscreen, microphone (for example, for voice input), mouse, touchpad, trackball, or any combination thereof. Output devices may be of any type suitable for providing output to one or more users and may include for example one or more screens for visual output, speakers, printers, or any combination thereof.

Memory 13 may be random-access memory having any structure and architecture known in the art, for use by processors, for example to run software. In a specific embodiment, memory 13 (such as non-volatile random-access memory (RAM) and/or read-only memory (ROM), including for example one or more levels of cached memory) may also form part of CPU 11. However, there are many different ways in which memory 13 may be coupled to computing device 10. Memory 13 may be used for a variety of purposes such as, for example, caching and/or storing data, programming instructions, and the like.

In one embodiment, computing device 100 includes one or more central processing units (CPU) 11, one or more interfaces 05, and one or more bus 18 (such as a peripheral component interconnect (PCI) bus). When acting under the control of appropriate software or firmware, CPU 11 may be responsible for implementing specific functions associated with the functions of a specifically configured computing device or machine. In at least one embodiment, CPU 11 may be caused to perform one or more of the different types of functions and/or operations under the control of software modules or components, which for example, may include an operating system and any appropriate applications software, drivers, and the like.

CPU 11 may include one or more processors such as, for example, a processor from one of the Intel, ARM, Qualcomm, and AMD families of microprocessors. In some embodiments, processors may include specially designed hardware such as application-specific integrated circuits (ASICs), electrically erasable programmable read-only memories (EEPROMs), field-programmable gate arrays (FPGAs), and so forth, for controlling operations of computing device 10. It should be further appreciated that CPU 11 may be one of a variety of system-on-a-chip (SOC) type hardware that may include additional hardware such as memory or graphics processing chips, such as a Qualcomm SNAPDRAGON™ or Samsung EXYNOS™ CPU or AMD Ryzen™ processor or Intel Xeon™ processor or others as are becoming increasingly common in the art, such as for use in mobile devices or integrated devices. As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit. Processors may carry out computing instructions under control of an operating system such as, for example, a version of Microsoft's WINDOWS™ operating system, Apple's Mac OS/X or iOS operating systems, some variety of the Linux operating system, Google's ANDROID™ operating system, or the like stored in memory.

In one embodiment, interfaces 05 enable wired or wireless communication between computing device 10 and another device via a network. Interfaces 05 are provided as network interface cards (NICs). Generally, NICs control the sending and receiving of data packets over a computer network; other types of interfaces 05 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (Wi-Fi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 05 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 7 illustrates one specific architecture for a computing device 10 for implementing one or more of the inventions described herein, it is by no means the only device architecture on which at least a portion of the features and techniques described herein may be implemented. For example, architectures having one or any number of processors may be used, and such processors may be present in a single device or distributed among any number of devices. In one embodiment, a single processor handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the computing device the present invention may employ one or more memories or memory modules (such as, for example, remote memory block and local memory) configured to store data, program instructions for the general-purpose network operations, or other information relating to the functionality of the embodiments described herein (or any combinations of the above). Program instructions may control execution of or comprise an operating system and/or one or more applications, for example. Memory 13 may also be configured to store operating system, data structures, configuration data, encryption data, historical system operations information, or any other specific or generic non-program information described herein. Because such information and program instructions may be employed to implement one or more systems or methods described herein, at least some network device embodiments may include non-transitory machine-readable storage media, which, for example, may be configured or designed to store program instructions, state information, and the like for performing various operations described herein. Examples of such non-transitory machine-readable storage media include, but are not limited to, magnetic media such as hard disks 12, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

Computing device 10 includes processors that may run software that carry out one or more functions or applications of embodiments of the invention, such as for example a client application. In many cases, one or more shared services may be operable in computing device 10, and may be useful for providing common services to client applications. Services may for example be WINDOWS™ services, user-space common services in a Linux environment, or any other type of common service architecture used with operating system.

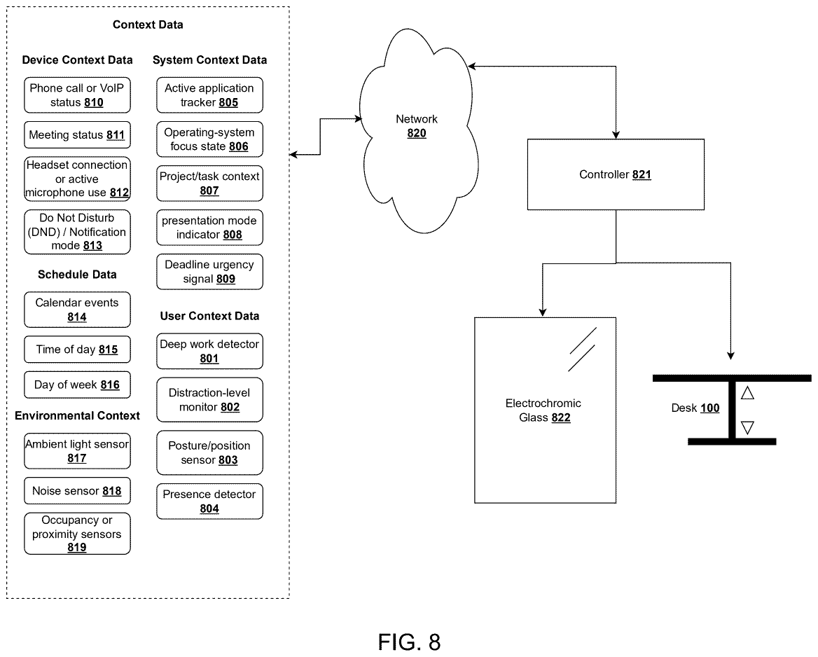

Referring now to FIG. 8, a context-adaptive cubicle system is shown that integrates a controller 821 configured to automatically control the opacity of electrochromic glass 822 and the position of a height-adjustable desk 100 in response to multiple types of contextual data. The contextual data may include information about the user's activity, posture, surrounding environment, connected devices, calendar or schedule information, and system-level indicators from a computing device. These contextual data sources may communicate with controller 821 through network 820, which may include wired or wireless communication such as Bluetooth, Wi-Fi, Ethernet, or other suitable protocols for local or cloud-based connectivity. The controller may have local processing and memory or may communicate with a remote computing server to implement adaptive control algorithms and synchronization with other cubicle systems in a shared workspace.

The electrochromic glass 822 may be formed of multiple independently controllable sections of dimmable glass, similar to the multi-layer configuration shown in FIGS. 1 and 2, in which separate top, middle, and bottom glass panels may be individually controlled to achieve varying degrees of privacy or light transmission. Each section may be driven by a corresponding output channel from controller 821, allowing fine-grained modulation of transparency across the cubicle walls. For example, during seated work, the middle and lower panels may be dimmed to shield a computer monitor from external view while maintaining the top panel in a transparent state to allow daylight entry. During a standing activity or video conference, the upper panels may be darkened for privacy while the lower panels remain partially transparent. Controller 821 may apply a low-voltage signal across selected electrochromic layers to change their optical transmission in accordance with the contextual data received through network 820.

User context data may provide insight into the user's level of focus, presence, or physical position. A deep work detector 801 may have hardware or software components that monitor typing cadence, cursor movement, and time spent within a single active window to infer when the user is performing high-focus work. When the deep work detector determines that the user has entered a focus state, controller 821 may increase the opacity of one or more sections of electrochromic glass 822 to reduce distractions and signal that the user is occupied. A distraction-level monitor 802 may include a sound or vibration sensor that evaluates ambient noise levels around the cubicle. If background noise exceeds a threshold, controller 821 may further increase dimming to promote concentration. A posture or position sensor 803 may detect whether the user is sitting or standing through pressure sensors integrated into desk 100, the chair, or a floor mat. Based on this data, controller 821 may raise or lower desk 100 automatically and adjust which glass sections are dimmed depending on user position. A presence detector 804 may use infrared, ultrasonic, or computer-vision techniques to identify occupancy within the cubicle. When absence is detected for a predetermined period, the controller may return glass 822 to a transparent state and power down the desk actuators to conserve energy.

System context data may include information derived from the user's computing environment. An active application tracker 805 may monitor the foreground software on the user's computer. When a video conferencing application such as Zoom or Microsoft Teams is detected, controller 821 may dim the upper sections of electrochromic glass 822 to create privacy and adjust desk 100 to a predefined camera height. When a design or writing application is in use, the glass may remain more transparent to allow openness and ambient light. An operating-system focus state 806 may be read from system-level signals, such as Focus Mode or Do Not Disturb settings, and controller 821 may interpret these signals as instructions to maintain a specific privacy profile until the focus state changes. A project or task context 807 may be derived from connected productivity tools such as task management or document editing software. For example, when a document is marked confidential, controller 821 may automatically dim the middle glass section to 70% opacity. A presentation mode indicator 808 may identify when the computer enters screen-sharing mode and adjust glass 822 to a uniform opacity to prevent background distractions. A deadline urgency signal 809 may be calculated from scheduled task deadlines, enabling controller 821 to increase privacy and minimize interruptions as deadlines approach.

Device context data may represent communication and status information from the user's devices. A phone call or VoIP status 810 may be obtained from a smartphone, headset, or communication software and may trigger automatic dimming when a call begins. Meeting status 811 may reflect real-time calendar participation and cause the cubicle to enter a predefined privacy state during the meeting. A headset connection or active microphone use signal 812 may be transmitted when a Bluetooth headset is connected or the microphone is active, prompting controller 821 to dim the panels to indicate an ongoing conversation. A Do Not Disturb or notification mode signal 813 may similarly maintain a selected opacity until the device returns to an available state.

Schedule data may be obtained from calendar systems or time-based inputs. Calendar events 814 may specify meeting times, focus blocks, or breaks. Controller 821 may begin transitioning the glass 822 toward a privacy level several minutes before the start of a scheduled event and restore transparency at its conclusion. Time-of-day data 815 may be used to balance circadian comfort, maintaining higher transparency during morning hours and gradually increasing dimming later in the day to reduce glare. Day-of-week context 816 may adjust behavior patterns such as more transparent panels on collaborative days and higher opacity midweek for individual work.

Environmental context data may provide physical measurements from sensors within or near the cubicle. An ambient light sensor 817 may monitor illumination levels and allow controller 821 to dynamically modulate glass 822 opacity to prevent glare or excessive brightness. A noise sensor 818 may measure sound pressure levels to infer nearby activity; if a threshold is exceeded, controller 821 may increase dimming to create a quieter visual environment. Occupancy or proximity sensors 819 may detect when another person approaches the cubicle perimeter, prompting controller 821 to dim the nearest section of glass 822 to a moderate opacity that communicates engagement while preserving collaboration.

The network 820 may facilitate bi-directional data transfer between controller 821, local sensors, user devices, and remote computing resources. It may use encrypted communication protocols to ensure secure transmission of user data. In some embodiments, multiple cubicle systems may share data over network 820 to coordinate lighting and privacy among adjacent workspaces, as described in connection with FIGS. 3-6, creating a responsive environment that adapts to group collaboration and individual privacy needs.

Controller 821 may include one or more microprocessors executing firmware that interprets contextual inputs to produce control signals for the electrochromic glass 822 and desk 100. These control signals may determine the voltage applied across the electrochromic material or the position of the desk actuators. The controller may include analog and digital interfaces, memory for storing user profiles, and communication modules for sensor integration. The system may employ an adaptive control algorithm trained to predict user preferences over time, enabling adaptive operation based on recurring patterns in the contextual data.

Desk 100 may have a linear actuator or motorized lifting mechanism that changes its height according to user posture, activity, or schedule data. For instance, when posture sensor 803 detects the user is standing, desk 100 may automatically rise to an ergonomic height and the upper glass sections of 822 may dim to improve privacy during standing activities. The integration of desk 100, electrochromic glass 822, and controller 821 allows for coordinated environmental and ergonomic adjustments that optimize user comfort, privacy, and productivity.

Electrochromic glass 822, when considered in conjunction with the glass panels of FIGS. 1 and 2, provides a physical medium for implementing the adaptive behaviors described herein. Each panel may be configured with transparent conductive oxide layers, an electrochromic layer, an ion storage layer, and an electrolyte as previously disclosed. By adjusting the applied voltage from controller 821, the system may control the flow of ions to change optical transmittance between approximately 5% and 90%. This range allows the cubicle to transition smoothly from an open, bright configuration to a private, opaque workspace in response to real-time context signals.

In operation, controller 821 may continuously evaluate data received from sensors and digital interfaces connected through network 820, determine an appropriate environmental state based on that data, and apply control signals to the electrochromic glass 822 and desk 100. The system may thus form a closed-loop feedback environment that dynamically responds to user behavior and environmental changes. This integration of contextual awareness and physical control enables the cubicle system to deliver both comfort and privacy while maintaining the aesthetic and functional benefits of a transparent workspace.

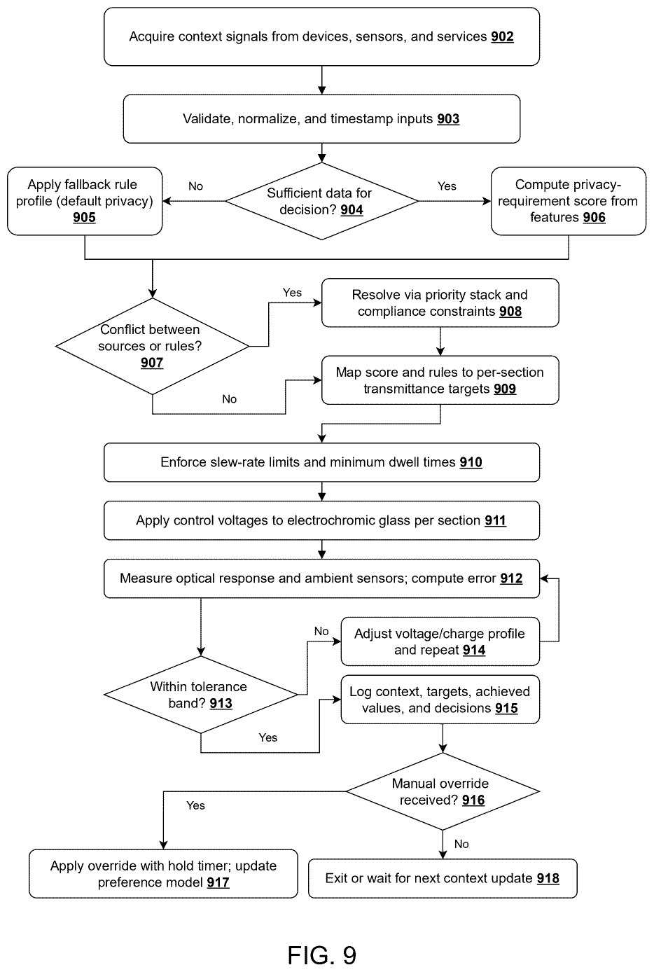

Referring now to FIG. 9, a flow diagram is illustrated showing an exemplary method for controlling the opacity of electrochromic glass 822 based on the context-adaptive system described with reference to FIG. 8. The method provides an automated control sequence executed by controller 821, which interprets contextual data gathered over network 820 and adjusts the transparency of electrochromic glass 822 in real time. The flowchart integrates the contextual sources, decision-making logic, and closed-loop feedback processes that allow the cubicle system to provide adaptive privacy and illumination control.

The method may begin by controller 821 initiating a monitoring routine. During this initialization, the controller may establish communication links with connected sensors, the user's computing devices, and network 820, verifying data channel availability before entering continuous operation. At step 902, controller 821 acquires contextual data from multiple input sources, such as user sensors, scheduling systems, and environmental detectors described previously in connection with FIG. 8. These inputs may include a focus signal from deep work detector 801, a noise level signal from distraction monitor 802, user posture from sensor 803, or meeting status from device context 810-813. Additional context such as ambient light, calendar events, or current operating-system focus state may also be obtained through APIs or short-range communication protocols. Each input may have a corresponding data tag or identifier to ensure accurate mapping between source and function.

At step 903, controller 821 validates and timestamps the received data. Validation may involve checking that the signals are within defined limits or that time synchronization is maintained across multiple devices. For instance, if a noise sensor 818 reports anomalously high values or a missing timestamp, the controller may discard the reading. The validated data may then be normalized to standard units such as decibels, lux, or percentage confidence values to permit consistent analysis across heterogeneous inputs.

At step 904, controller 821 determines whether sufficient data is available to make a reliable decision. In some cases, missing context data, such as a disconnected presence sensor 804 or unavailable calendar feed, may prevent accurate state estimation. If insufficient data is detected, the controller proceeds to step 905, where a fallback profile is applied. The fallback profile may correspond to a default privacy level, for example setting all sections of electrochromic glass 822 to a mid-level opacity such as 50 percent transmission, ensuring adequate user comfort and energy efficiency even under degraded sensing conditions. If sufficient data is available, the process advances to step 906, where controller 821 computes a privacy requirement score based on weighted contextual factors. The privacy score may be a composite value derived from user engagement metrics, active applications, meeting presence, and noise levels. For example, a high score may result from detection of a confidential meeting event and elevated background noise, indicating the need for increased privacy.

At step 907, controller 821 may check for conflicts among context sources or decision rules. A conflict may arise, for example, when the operating-system focus mode requests privacy while a calendar event designates an open-collaboration session. If a conflict is detected, controller 821 proceeds to step 908, where a rule-resolution engine evaluates priority hierarchies, legal compliance constraints, and user preference weights. The highest priority input may be implemented, or a blended response may be calculated by averaging the relevant transmittance targets. If no conflict exists, the process continues directly to step 909, where the computed privacy score and resolved rule set are mapped to specific transmittance targets for each section of electrochromic glass 822. In one example, the top section may be set to 70 percent opacity for glare reduction, the middle section to 90 percent for monitor privacy, and the bottom section to 40 percent to maintain natural light at the floor level.

At step 910, the controller enforces slew-rate and dwell-time limits to prevent abrupt visual transitions and to protect the electrochromic material from excessive electrical cycling. The system may limit the rate of change in transmission to less than five percent per second and ensure that any applied state persists for at least fifteen seconds before further modification. The method then proceeds to step 911, where the controller applies the computed voltages or currents to the corresponding sections of electrochromic glass 822 through dedicated driver circuits. Each section may be independently driven according to its transmittance target, and the output signals may be pulse-width modulated to achieve fine control of ion migration within the electrochromic layers.

At step 912, the system performs closed-loop verification by sampling optical and ambient sensors. These may include internal photodiodes attached to the glass or external ambient light sensors 817. The controller computes the error between the measured and desired transmittance for each section. At step 913, the controller determines whether the measured value lies within an acceptable tolerance band, such as plus or minus two percent of the target transmission. If the values fall outside tolerance, the controller advances to step 914, where it adjusts the applied voltage or charge profile and repeats the verification loop at step 912. This feedback ensures that factors such as temperature, humidity, or material aging do not degrade optical accuracy. If the results are within tolerance, the method proceeds to step 915, where all operational data—including context inputs, calculated targets, achieved values, and resolution decisions—are logged in memory. These data records may be used for diagnostics, compliance verification, or to train adaptive algorithms for future optimization.

At a next step 916, controller 821 checks whether a manual override command has been received. A user may initiate an override through a graphical interface, remote application, or voice command. If an override is detected, the system advances to step 917, where the requested opacity values are applied immediately, and a hold timer is initiated to maintain these settings for a predefined duration, such as five minutes. The override action and its associated context snapshot may be stored to update the user preference model used in future decisions. If no override is present, the controller advances to step 918, where it either exits the control cycle or enters a waiting state for the next context update. The waiting interval may range from a few seconds to several minutes, depending on the refresh rate of the connected sensors.

Throughout this process, controller 821 may communicate bidirectionally with network 820 to synchronize operation among multiple cubicle systems as described in connection with FIGS. 3-6. For example, when several cubicles are engaged in a collaborative session, each controller may broadcast its calculated privacy score and coordinate to produce a shared transparency gradient across the workspace. The same feedback principles and control steps illustrated in FIG. 9 may be used in these networked scenarios, ensuring consistent user experience across the environment.

What is claimed is:

1. A cubicle system comprising a plurality of electrochromic glass panels configured to transition between a transparent state and an opaque state in response to an applied voltage;
a controller including at least one processor, a memory, and a driver circuit coupled to the electrochromic glass panels;
and a plurality of sensors including a posture sensor, a noise sensor, a light sensor, and a presence detector;
wherein the controller is programmed to acquire context signals from the sensors;
compute a privacy-requirement value based on weighted contributions of the context signals;
map the privacy-requirement value to target transmittance levels for the electrochromic glass panels according to a stored look-up table; and
output control voltages through the driver circuit to achieve the target transmittance levels; and
wherein the controller further includes feedback logic configured to receive optical transmittance measurements from the electrochromic glass panels and to iteratively adjust the control voltages until the measured transmittance is within a predefined tolerance band.

2. The cubicle system of claim 1, wherein the feedback logic enforces a slew-rate limit that restricts the rate of change of transmittance to less than five percent per second to prevent user discomfort and material degradation.

3. The cubicle system of claim 1, wherein the controller is configured to receive a manual override command from a local interface or wireless application, suspend automatic adjustment for a predetermined hold period, and store a user preference corresponding to the override in the memory.

4. The cubicle system of claim 1, further comprising a height-adjustable desk coupled to a motorized actuator controlled by the controller, wherein the controller adjusts both desk height and glass panel opacity in coordination with the detected posture of a user.

5. The cubicle system of claim 1, wherein the controller communicates with controllers of adjacent cubicles over a local network and synchronizes the target transmittance levels to generate a transparency gradient across a shared workspace.

6. The cubicle system of claim 1, wherein the controller compensates for variations in ambient illumination by modifying the target transmittance according to the light sensor reading and a calibration curve stored in the memory.

7. The cubicle system of claim 1, wherein the controller continuously records context signals, target transmittance values, and applied voltages to a non-volatile log for diagnostic analysis.

8. The cubicle system of claim 1, wherein the controller communicates with the sensors using a short-range wireless protocol selected from Bluetooth Low Energy, IEEE 802.15.4, or Wi-Fi Direct, and encrypts sensor data prior to transmission.

9. The cubicle system of claim 1, wherein upon detection of invalid or missing sensor data, the controller applies a default privacy profile that sets each electrochromic glass panel to a transmittance between forty and sixty percent.

10. A method for controlling opacity of electrochromic glass panels in a cubicle system comprising the steps of acquiring user-context signals from a posture sensor, noise sensor, light sensor, and presence detector comprising the steps of:
validating and timestamping each signal;
determining whether sufficient data is available to compute a privacy-requirement value;
applying a default transmittance profile if insufficient data is available, otherwise computing the privacy-requirement value from the validated signals;
mapping the privacy-requirement value to target transmittance levels for each electrochromic glass panel;
outputting control voltages to the panels to achieve the corresponding target transmittance levels;
measuring actual transmittance using optical sensors;
and adjusting the control voltages in a feedback loop until the measured transmittance is within a tolerance range.

11. A non-transitory computer-readable medium storing instructions that, when executed by a processor of a cubicle controller, perform the method of claim 10.
